(19) United States
(12) Patent Application Publication
(10) Pub. No.: US 2011/0235780 A1
(43) Pub. Date: Sep. 29, 2011

(54) RADIATION IMAGING SYSTEM AND OFFSET CORRECTION METHOD THEREOF

(75) Inventor: Takuji TADA, Kanagawa (JP)

(73) Assignee: FUJIFILM CORPORATION, Tokyo (JP)

(21) Appl. No.: 13/016,980

(22) Filed: Jan. 29, 2011

(30) Foreign Application Priority Data
Mar. 29, 2010 (JP) 2010-074248
Sep. 22, 2010 (JP) 2010-211940

(51) Int. Cl. G01N 23/04

(52) U.S. Cl. 378/62

(57) ABSTRACT

A radiation imaging system includes first and second gratings, a scanning system, a detector, an image generator, a storage, and a correction processing section. The first grating includes first grating modules arranged cylindrically about a virtual line. The virtual line passes through a focal point. The second grating includes second grating modules arranged cylindrically and coaxially about the virtual line with a larger radius. Grating lines of the first and second gratings are parallel with the virtual line. The scanning mechanism scans the second grating orthogonally to the virtual line. The detector is divided into segments corresponding to the second grating modules. The storage stores an offset value, per segment, corresponding to an inclination angle of the second grating module relative to scanning. The correction processing section corrects a phase differential image on a segment-by-segment basis based on the offset value.

### FIELD OF THE INVENTION

The present invention relates to a radiation imaging system for capturing an image of an object using radiation such as X-ray and more particularly to a radiation imaging system for performing phase imaging using two gratings arranged between a radiation source and a radiation image detector, and an offset correction method thereof.

### BACKGROUND OF THE INVENTION

X-ray attenuates while it passes through a substance. The attenuation depends on an atomic number of an element constituting the substance and density and thickness of the substance. A probe for examining the inside of an object using X-ray exploits this X-ray attenuation property. X-ray imaging is commonly used in medical diagnoses and non-destructive inspections.

A common X-ray imaging system captures a radiograph or X-ray transmission image of an object arranged between an X-ray source for emitting X-ray and an X-ray image detector for detecting the X-ray. The X-ray emitted from the X-ray source attenuates or is absorbed by the object depending on the object's properties (atomic number, density, thickness) while the X-ray passes through the object, and then enters each pixel in the X-ray image detector. Thereby, the X-ray image detector detects and produces an X-ray absorption image of the object. A flat panel detector (FPD), photostimulable phosphor, and a combination of an intensifying screen and a film are commonly used as the X-ray image detectors.

The X-ray absorption property of a substance decreases as the atomic number of the element constituting the substance decreases. This causes a problem that a sufficient contrast cannot be obtained in the X-ray absorption image of living soft tissue or soft materials. For example, cartilage in a joint of a human body and synovial fluid surrounding the cartilage are mainly made of water, so there is little difference between their amounts of X-ray absorption, resulting in little difference in contrast.

Recently, X-ray phase imaging has been studied actively to solve the above problem. The X-ray phase imaging obtains an image (hereafter referred to as phase contrast image) based on phase changes (angle changes), instead of intensity changes, of the X-ray caused by the object through which the X-ray passes. Generally, when the X-ray is incident on the object, the object interacts with the phase of the X-ray more strongly than with the intensity of the X-ray. Accordingly, the X-ray phase imaging using the phase difference obtains a high contrast image even if the object is composed of components with little difference in their X-ray absorptivity. Recently, an X-ray imaging system using an X-ray Talbot interferometer is devised as an example of the X-ray phase imaging. The X-ray Talbot interferometer is composed of an X-ray source, two transmission diffraction gratings, and an X-ray image detector (see, for example, Japanese Patent Laid-Open Publication No. 2008-200359, and C. David, et al., “Differential X-ray Phase contrast imaging using a shearing interferometer”, Applied Physics Letters, Vol. 81, No. 17, October, 2002, page 3287).

In an X-ray Talbot interferometer, an object is arranged between an X-ray source and a first diffraction grating. A second diffraction grating is arranged downstream of the first diffraction grating by the Talbot length defined by the grating pitch of the first diffraction grating and the X-ray wavelength. The X-ray image detector is arranged behind the second diffraction grating. A Talbot length is a distance between the first diffraction grating and a position at which the X-ray passed through the first diffraction grating forms a self image of the first diffraction grating due to the Talbot effect. The self image is modulated due to the interaction between the X-ray and the object arranged between the X-ray source and the first diffraction grating, namely, the interaction changes the phase of the X-ray.

The X-ray Talbot interferometer detects moiré fringes generated by superposition (intensity modulation) of the self image of the first diffraction grating and the second diffraction grating using a fringe-scanning method. Then the X-ray Talbot interferometer obtains a phase contrast image of the object H from changes in the moiré fringes caused by the object H. In the fringe-scanning method, images are captured while the second diffraction grating is translationally moved in a direction substantially parallel to the plane of the first diffraction grating and substantially vertical to the grating direction of the first diffraction grating at a scanning pitch which is one of equally-divided parts of a grating pitch, and then a phase differential image is obtained from a phase shift value of the intensity changes in the pixel data, obtained by each pixel in the X-ray image detector, caused by the scanning. The phase shift value is a value of the phase shift between the case where the object H is present and the case where the object H is absent. The phase differential image corresponds to angular distribution of the X-ray refracted by the object. The phase differential image is integrated in the fringe-scanning direction. Thereby, a phase contrast image of the object is obtained. Because the pixel data is a signal whose intensity is periodically modulated by the scanning, a set of pixel data obtained by the scanning is referred to as an intensity modulated signal. An imaging apparatus using laser light instead of X-ray also employs the fringe-scanning method (for example, see Hector Canabal, et al., “Improved phase-shifting method for automatic processing of moiré deflectograms” Applied Optics, Vol. 37, No. 26, September 1998, page 6227).

An X-ray imaging system employing an X-ray Talbot interferometer normally uses an X-ray source for emitting the X-ray in cone beams from an X-ray focal point. To ensure a wide field of view without degrading the image quality, it is preferable to arrange the first and second diffraction gratings along concave surfaces (cylindrical surfaces) having a common center axis passing through the X-ray focal point. It is difficult, however, to produce a large concave grating in a single-piece. U.S. Pat. No. 7,522,698 corresponding to Japanese Patent Laid-Open Publication No. 2007-203061 suggests a concave grating configured using multiple grating modules arranged along a concave surface. U.S. Pat. No. 7,180,979 suggests to move each of the grating modules individually using a driving device provided per grating module and to move the entire concave grating using a common driving device so as to perform the above-described scanning.

It is unrealistic to provide the driving device to each of the grating modules constituting the concave grating, as described in U.S. Pat. No. 7,522,698, because the configuration becomes complicated and the cost increases. It is preferable to provide a common driving device to the entire grating so as to linearly move the entire grating in one direction.

When the concave grating is linearly moved, each grating module has a different inclination angle relative to the moving direction, which results in a different scanning pitch. For example, the grating modules located at around the side ends of the grating has larger inclination angles relative to the moving direction when compared to a grating module located at the center of the grating. The actual scanning pitches required for the grating modules located at the side ends of the grating are larger than the scanning pitch for the grating module located at the center. Different scanning pitches lead to changes in the phases of the intensity modulate signals. Namely, a phase sift caused by the inclination of the grating module is added as an offset value to a phase differential image obtained with the fringe-scanning. Thus, the image quality of the phase contrast image is degraded toward the side end portions due to the grating modules with large inclination angles.

### SUMMARY OF THE INVENTION

An object of the present invention is to provide a radiation imaging system and a correction method thereof to reduce an influence caused by inclination of grating modules configured to form a concave surface.

In order to achieve the above and other objects, a radiation imaging system of the present invention includes a first grating, a second grating, a scanning section, a radiation image detector, a phase differential image generator, an offset value storage, and a correcting section. The first grating is composed of two or more first grating modules arranged along at least a part of a virtual first cylindrical surface having a virtual line as a center axis. The virtual line passes through a focal point of a radiation source. The grating line of the first grating is in the same direction as the virtual line. The second grating is composed of two or more second grating modules arranged along at least a part of a virtual second cylindrical surface. The second cylindrical surface is coaxial with the first cylindrical surface and has a larger radius than the first cylindrical surface. A grating line of the second grating is in the same direction as the virtual line. The scanning section moves one of the first grating and the second grating relative to the other in a scanning direction orthogonal to the virtual line. The radiation image detector has a detection surface for detecting the radiation passed through the first grating and the second grating to obtain pixel data while one of the first grating and the second grating is moved relative to the other by the scanning section. The detection surface is divided into two or more segments. The segments corresponds to the second grating modules, respectively. The phase differential image generator calculates a phase shift value of an intensity modulated signal to produce a phase differential image based on the phase shift value. The intensity modulated signal represents a relation between the pixel data and a relative position between the first grating and the second grating. The offset value storage stores an offset value of the phase shift value. The offset value corresponds to an inclination angle of the second grating module relative to the scanning direction. The offset value storage stores the offset values corresponding to the segments, respectively. The correcting section corrects the phase differential image on a segment-by-segment basis based on the offset value.

It is preferable that the offset value is a value calculated by (1−cos θ)π/cos θ where θ denotes the inclination angle.

It is preferable that the radiation imaging system further includes a phase contrast image generator for integrating the phase differential image corrected by the correcting section to produce a phase contrast image.

It is preferable that each of the first grating modules is an absorption grating and projects the radiation from the radiation source as a fringe image to the second grating module corresponding to the first grating module.

It is preferable that each of the first grating modules is a phase grating and forms a fringe image of the radiation from the radiation source at the second grating module corresponding to the first grating module due to Talbot effect.

A radiation imaging system of the present invention includes a grating, a radiation image detector, a phase differential image generator, an offset value storage, and a correcting section. The grating is composed of two or more grating modules arranged along at least a part of a virtual cylindrical surface having a virtual line as a center axis. The virtual line passes through a focal point of a radiation source. The grating line of the grating is in the same direction as the virtual line. The radiation image detector has a detection surface divided into two or more segments. The segments correspond to the grating modules, respectively. The detection surface has a charge collection electrode per pixel. The charge collection electrode collects charge converted by a radiation conversion layer. The charge collection electrode is composed of two or more linear electrode groups arranged to have mutually different phases in a direction orthogonal to the virtual line. The phase differential image generator calculates a phase shift value of an intensity modulated signal to produce a phase differential image based on the phase shift value. The intensity modulated signal represents changes in pixel data obtained by each of the linear electrode groups. The offset value storage stores an offset value of the phase shift value. The offset value corresponds to an inclination angle of the grating module relative to the direction orthogonal to the virtual line. The offset value storage stores the offset values corresponding to the segments, respectively. The correcting section for correcting the phase differential image on a segment-by-segment basis based on the offset value.

An offset correction method for a radiation imaging system comprising a moving step, an obtaining step, a producing step, and a correcting step. In the moving step, one of a first grating and a second grating is moved relative to the other in a direction orthogonal to a virtual line. The first grating is composed of two or more first grating modules arranged along at least a part of a virtual first cylindrical surface having the virtual line as a center axis. The virtual line passes through a focal point of a radiation source. The grating line of the first grating is in the same direction as the virtual line. The second grating is composed of two or more second grating modules arranged along at least a part of a virtual second cylindrical surface. The second cylindrical surface is coaxial with the first cylindrical surface and has a larger radius than the first cylindrical surface. A grating line of the second grating is in the same direction as the virtual line. In the obtaining step, the radiation passed through the first grating and the second grating is detected by a detection surface of the radiation image detector to obtain pixel data while one of the first grating and the second grating is moved relative to the other. The detection surface is divided into two or more segments. The segments correspond to the second grating modules, respectively. In the producing step, a phase shift value of an intensity modulated signal is calculated to produce a differential image based on the phase shift value. The intensity modulated signal represents a relation between the pixel data and a relative position between the first grating and the second grating. In the correcting step, the phase differential image is corrected on a segment-by-segment basis based on an offset value of the phase shift value. The offset value corresponds to an inclination angle of the second grating module relative to the direction orthogonal to the virtual line. The offset values are stored corresponding the segments, respectively.

In the present invention, the phase differential image is corrected on a segment-by-segment basis based on the offset value of the phase shift value. The offset value corresponds to the inclination angle of the second grating module relative to the scanning line. The offset values are stored corresponding to the respective segments. The segments correspond to the respective second grating modules. Thereby, the influence caused by the inclination of the grating module is reduced. Because one offset value is stored per segment, only a small storage capacity is required.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a perspective view showing a configuration of an X-ray imaging system according to a first embodiment of the present invention;

FIG. 2A is a plane view of a first absorption grating viewed from an optical axis direction;

FIG. 2B is a plane view of a second absorption grating viewed from the optical axis direction;

FIG. 3 is a perspective view showing a configuration of a flat panel detector;

FIG. 4 is a cross section showing structures of the first and second absorption gratings;

FIG. 5 is an explanatory view showing a fringe scanning method;

FIG. 6 is a graph illustrating pixel data (intensity modulated signal) modulated by scanning;

FIG. 7 is a perspective view showing an effective grating period of a grating module tilted relative to a scanning direction

FIG. 8 is a graph describing a method for calculating an offset value;

FIG. 9 shows a detection surface of the FPD divided into multiple segments; and

FIG. 10 is a perspective view showing a configuration of an X-ray image detector according to a second embodiment of the present invention.

### DESCRIPTION OF THE PREFERRED EMBODIMENTS

### First Embodiment

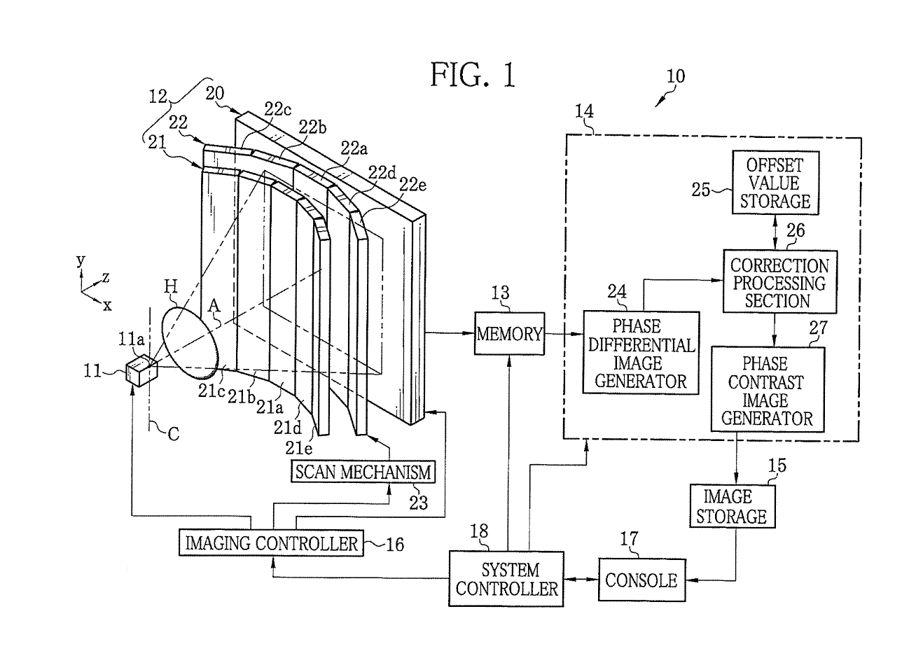

In FIG. 1, an X-ray imaging system 10 according to a first embodiment of the present invention is composed of an X-ray source 11, an imaging unit 12, a memory 13, an image processor 14, an image storage 15, an imaging controller 16, a console 17, and a system controller 18. The X-ray source 11 irradiates an object H with X-ray. The imaging unit 12 is opposed to the X-ray source 11 and detects the X-ray, emitted from the X-ray source 11 and passed through the object H, to generate image data. The memory 13 stores the image data read from the imaging unit 12. The image processor 14 processes multiple frames of image data stored in the memory 13 to generate a phase contrast image. The image storage 15 stores the phase contrast image generated by the image processor 14. The imaging controller 16 controls the X-ray source 11 and the imaging unit 12. The console 17 is composed of an operating section, a monitor, and the like. The system controller 18 controls the overall operation of the X-ray imaging system 10 based on an operation signal inputted through the console 17.

The X-ray source 11 is composed of a high voltage generator, an X-ray tube, a collimator, and the like (all not shown). Under the control of the imaging controller 16, the X-ray source 11 irradiates the object H with the X-ray. The X-ray tube is, for example, a rotating anode type X-ray tube. The X-ray tube emanates electron beams from a filament in accordance with voltage from the high voltage generator. The electron beams impinge on a rotating anode rotating at a predetermined speed to generate the X-ray. The rotating anode prevents the electron beams from impinging on the same spot and thus reduces deterioration of the rotating anode. A spot of the rotating anode on which the electron beams impinge is an X-ray focal point. The X-ray is emitted from the X-ray focal point. The collimator restricts an X-ray irradiation field of the X-ray tube to shield an area of the object H other than the area under examination from the X-ray.

The imaging unit 12 is provided with a flat panel detector (hereafter referred to as FPD) 20, a first absorption grating 21, and a second absorption grating 22. The FPD 20 is composed of a semiconductor circuit. The first absorption grating 21 and the second absorption grating 22 are used for detecting phase changes (angle changes) of the X-ray caused by the object H to perform phase imaging. The FPD 20 is arranged such that its detection surface is orthogonal to a direction (hereafter, referred to as z direction) of an optical axis A of the X-ray emitted from the X-ray source 11.

The first absorption grating 21 is composed of first to fifth grating modules 21a to 21e. Each of the first to fifth grating modules 21a to 21e is a rectangular strip grating (plate grating) extending in a direction (hereafter referred to as y direction) in a plane orthogonal to z direction. The first to fifth grating modules 21a to 21e are arranged along a virtual cylindrical surface having a virtual line C as a center axis. The virtual line C passes through an X-ray focal point 11a of the X-ray source 11 and extends in the y direction.

The second absorption grating 22 is composed of first to fifth grating modules 22a to 22e. The second absorption grating 22 is arranged between the first absorption grating 21 and the FPD 20. As with the first to fifth grating modules 21a to 21e of the first absorption gratings 21, each of the first to fifth grating modules 22a to 22e is a rectangular strip grating (plate grating) extending in the y direction. The first to fifth grating modules 22a to 22e are arranged along a virtual cylindrical surface having the virtual line C as a center axis, namely, the above described virtual cylindrical surfaces for the first and second absorption gratings 21 and 22 are coaxial.

Of the first to fifth grating modules 21a to 21e of the first absorption grating 21, the first grating module 21a is arranged orthogonal to the optical axis A. Of the first to fifth grating modules 22a to 22e of the second absorption grating 22, the first grating module 22a is arranged orthogonal to the optical axis A.

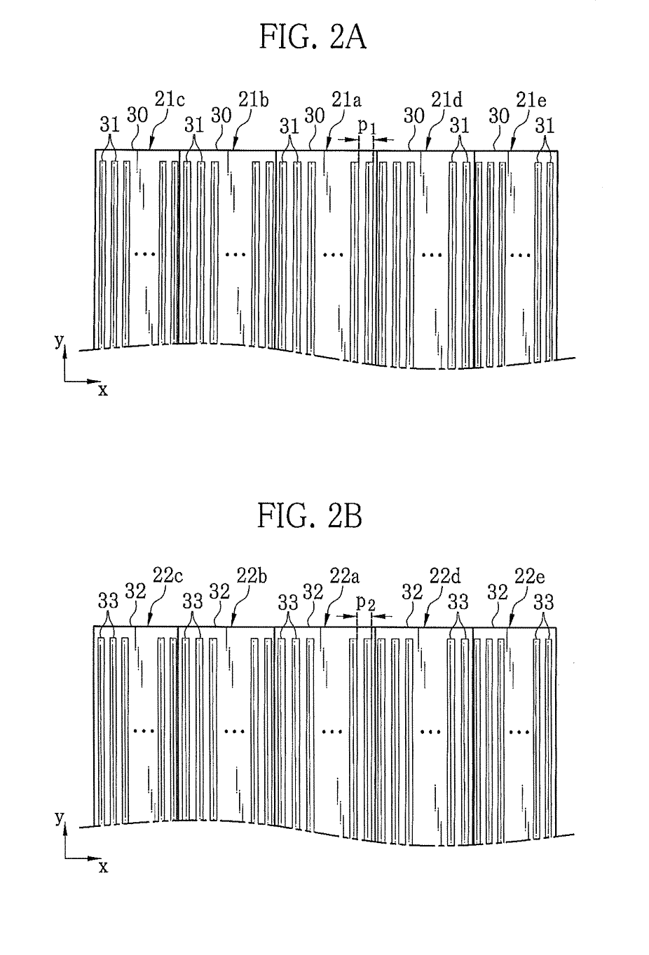

In FIG. 2A, each of the first to fifth grating modules 21a to 21e of the first absorption grating 21 is composed of an X-ray transmission substrate or X-ray translucent substrate 30, such as a glass substrate, and a plurality of X-ray shield members (grating line) 31 extending in the y direction. The X-ray shield members 31 are arranged on the X-ray translucent substrate 31 at a predetermined pitch p₁ with a regular spacing d₁ in a direction (hereafter referred to as x direction) orthogonal to the z direction and the y direction. In FIG. 28, each of the first to fifth grating modules 22a to 22e of the second absorption grating 22 is composed of an X-ray transmission substrate or X-ray translucent substrate 32 and a plurality of X-ray shield members (grating line) 33 extending in the y direction. The X-ray shield members 33 are arranged on the X-ray translucent substrate 32 at a predetermined pitch p₂ with a regular spacing d₂ in the x direction.

It is preferable that the X-ray shield members 31 and 33 are made of metal having excellent X-ray absorption property, for example, gold, lead, or the like. The slits (regions of the above described spacings d₁ and d₂) of the first and second absorption gratings 21 and 22 may not necessary be empty spaces, and may be filled with a low X-ray absorption material, for example, polymer or light metal.

The imaging unit 12 is provided with a scan mechanism 23. The scan mechanism 23 moves the second absorption grating 22 in the x direction to change the relative position between the first absorption grating 21 and the second absorption grating 22. Hereafter, scanning refers to moving the second absorption grating 22 using the scan mechanism 23. A scanning direction refers to the moving direction of the second absorption grating 22. The scan mechanism is, for example, an actuator such as a piezoelectric element. The scan mechanism 23 is driven under the control of the imaging controller 16 at the time of fringe-scanning which will be described later. Image data obtained by the imaging unit 12 in each scanning step or position of the second absorption grating 22 is stored in the memory 13.

The image processor 14 further includes a phase differential image generator 24, an offset value storage 25, a correction processing section 26, and a phase contrast image generator 27. The phase differential image generator 24 generates or produces a phase differential image based on multiple frames of image data captured by the imaging unit 12 and stored in the memory 13. The offset value storage 25 stores an offset value of a phase shift value of an intensity modulates signal, which will be described later. The correction processing section 26 performs offset correction to the phase differential image based on the offset value stored in the offset value storage 25. The phase contrast image generator 27 integrates the corrected phase differential image in the x direction to produce the phase contrast image. The phase contrast image is stored in the image storage 15. Then, the phase contrast image is outputted to the console 17 and displayed on a monitor (not shown). Instead of the phase contrast image, the phase differential image may be stored in the image storage 15 and displayed on the monitor.

The offset values stored in the offset value storage 25 corresponds to the inclination angles of the grating modules of the first and second absorption gratings 21 and 22, which will be detailed later.

The console 17 is provided with a monitor and an input device (not shown). The operator inputs an instruction for imaging and details of the instruction using the input device. Examples of the input device include a switch, a touch panel, a mouse, and a keyboard. Operating the input device, the operator inputs a tube voltage of the X-ray tube, an X-ray imaging condition such as X-ray irradiation time, imaging timing, and the like. The monitor is an LCD, CRT, or the like. The monitor displays text information such as the X-ray imaging condition and the phase contrast image.

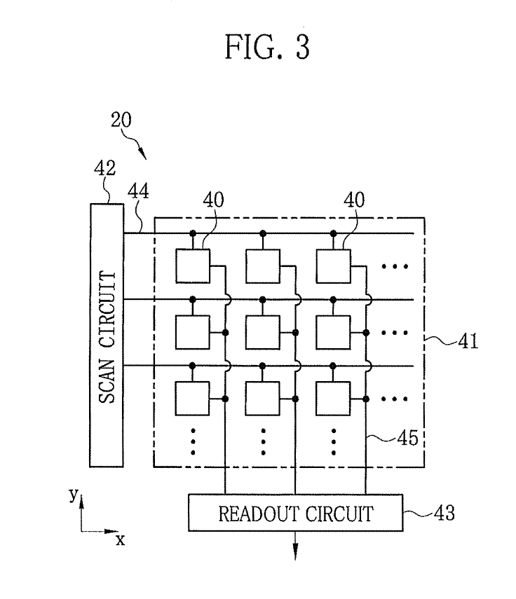

In FIG. 3, the FPD 20 is composed of an imaging section 41, a scan circuit 42, a readout circuit 43. The imaging section 41 is composed of pixels 40 arranged in two dimensions (x and y directions) on an active matrix substrate. Each pixel 40 converts the X-ray into electric charge and accumulates the electric charge. The scan circuit 42 controls timing to read the electric charge from the imaging section 41. The readout circuit 43 reads the electric charge accumulated in each pixel 40 to convert the electric charge into image data and stores the image data. A scan line 44 connects the scan circuit 42 and the pixels 40 in each row. A signal line 45 connects the readout circuit 43 and the pixels 40 in each column. The pixels 40 are arranged at a pitch of approximately 100 μm in the x and y directions.

The pixels 40 are direct conversion type X-ray sensing elements. In this case, each of pixels 40 directly converts the X-ray into the electric charge using a conversion layer (not shown) made from amorphous selenium and the like and then accumulates the electric charge in a capacitor (not shown) connected to an electrode below the conversion layer. To each pixel 40, a TFT switch (not shown) is connected. A gate electrode of the TFT switch is connected to the scan line 44. A source electrode is connected to the capacitor. A drain electrode is connected to the signal line 45. When a drive pulse from the scan circuit 42 turns on the TFT switch, the electric charge accumulated in the capacitor the signal line 45 is transferred to the signal line 45.

Alternatively, the pixels 40 may be indirect conversion type X-ray sensing elements. In this case, each of the pixels 40 converts the X-ray into visible light using a scintillator (not shown) made from gadolinium oxide (Gd₂O₃), cesium iodide (CsI), or the like and then converts the visible light into electric charge using a photodiode (not shown) to accumulate the electric charge. In this embodiment, the FPD having a TFT panel is used as the radiation image detector. Alternatively or in addition, various types of radiation image detectors having a solid image sensor such as a CCD sensor or a CMOS sensor may be used.

The readout circuit 43 is composed of an integrating amplifier, a correction circuit, an A/D converter, and the like (all not shown). The integrating amplifier integrates the electric charge outputted from each of the pixels 40 through the signal lines 45 to convert the electric charge into a voltage signal (image signal). The A/D converter converts the image signal into digital image data. The correction circuit performs gain correction, linearity correction, and the like to the image data. Then, the correction circuit inputs the corrected image data to the memory 13.

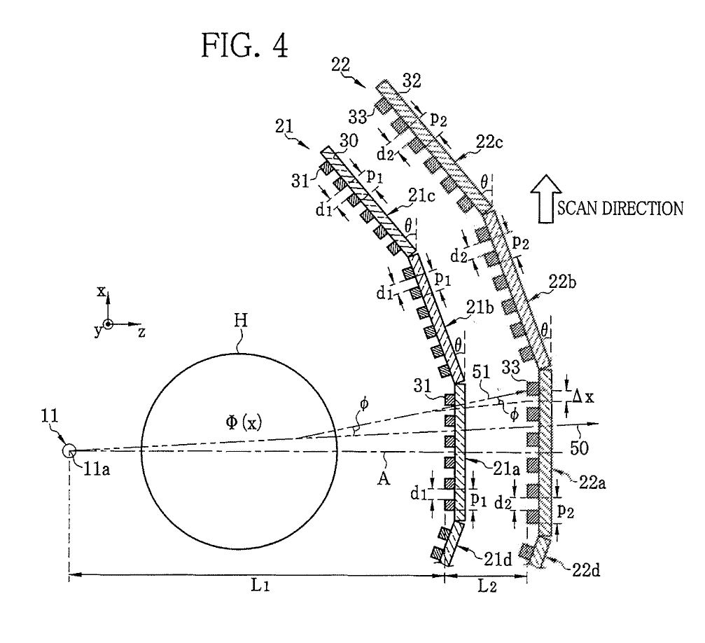

In FIG. 4, the first and second absorption gratings 21 and 22 are arranged such that the corresponding grating modules are parallel. Each grating module faces the X-ray focal point 11a. Each grating module of the second absorption grating 22 is arranged such that the X-ray passed through the first absorption grating 21 is projected to the corresponding second absorption grating 22. Namely, the shapes of the first and second absorption gratings 21 and 22 are similar with respect to the X-ray focal point 11a, and the second absorption grating 22 is a scale-up of the first absorption grating 21.

Regardless of the presence or absence of the Talbot effect, the first and second absorption gratings 21 and 22 are arranged to form a linear projection of the X-ray passing through the slits (regions of the spacings d₁ and d₂). To be more specific, each of the spacings d₁ and d₂ is set at the size sufficiently larger than a peak wavelength of the X-ray emitted from the X-ray source 11. Thereby, most of the emitted X-ray passes through the slits in straight lines without diffraction at the slits. For example, when tungsten is used as the rotating anode of the X-ray tube and the tube voltage is set at 50 kV, the peak wavelength of the X-ray is approximately 0.4 Å. In this case, most of the X-ray is linearly projected without diffraction at the slits when each of the spacings d₁ and d₂ is at a value in a range approximately from 1 μm to 10 μm. Each of the grating pitches p₁ and p₂ is at a value in a range approximately from 2 μm to 20 μm.

The X-ray source 11 emits the X-ray in cone beams having the X-ray focal point 11a as a light emission point. Accordingly, a projection or projected image (hereafter referred to as G1 image or fringe image) of the first absorption grating 21 projected or formed by the X-ray passed through the first absorption grating 21 is enlarged in proportion to a distance from the X-ray focal point 11a. The grating pitch p₂ of the second absorption grating 22 is determined such that the slits of the second absorption grating 22 substantially coincide with the periodic pattern of the bright areas in the G1 image at the second absorption grating 22. When L₁ denotes a distance between the X-ray focal point 11a and the first absorption grating 21 and L₂ denotes a distance between the first absorption grating 21 and the second absorption grating 22, the grating pitch p₂ is determined to satisfy a mathematical expression (1).

$${p}_{2} = \frac{{L}_{1} + {L}_{2}}{{L}_{1}} {p}_{1} \qquad ( 1 )$$

In the Talbot interferometer, the distance L₂ between the first absorption grating 21 and the second absorption grating 22 is restricted by the Talbot length that is defined by the grating pitch p₁ of the first diffraction grating 21 and the X-ray wavelength. In the imaging unit 12 of this embodiment, on the other hand, the first absorption grating 21 projects the incident X-ray without diffraction. An image similar to the G1 image of the first absorption grating 21 is obtained at any position behind the first absorption grating 21. As a result, the distance L₂ can be set independently of or without reference to the Talbot length.

As described above, the imaging unit 12 of this embodiment is not a Talbot interferometer. With the assumption that the X-ray is diffracted by the first absorption grating 21 to produce the Talbot effect, a Talbot length Z is represented by a mathematical expression (2) where p₁ denotes the grating pitch of the first absorption grating 21, p₂ denotes the grating pitch of the second absorption grating 22, λ denotes the X-ray wavelength (the peak wavelength), and m denotes a positive integer.

$$Z = m \frac{{p}_{1} {p}_{2}}{λ} \qquad ( 2 )$$

The mathematical expression (2) represents the Talbot length when the X-ray source 11 emits the X-ray in a cone beam. The mathematical expression (2) is disclosed in “Sensitivity of X-ray phase Imaging based on Talbot Interferometry” (Atsushi Momose, et al., Japanese Journal of Applied Physics, Vol. 47, No. 10, October 2008, page 8077).

In this embodiment, the distance L₂ can be set independently of the Talbot length as described above. To make the imaging unit 12 slim or low-profile in the z direction, the distance L₂ is set to be shorter than the minimum Talbot length Z obtained when m=1. Namely, the distance L₂ is set at a value in a range satisfying a mathematical expression (3),

$${L}_{2} < \frac{{p}_{1} {p}_{2}}{λ} \qquad ( 3 )$$

To generate a periodic pattern image with high contrast, it is preferable that the X-ray shield members 31 and 33 completely shield (absorb) the X-ray. Although the above-described materials (gold, lead, or the like) having the high X-ray absorption property are used, the transmission X-ray, which has not been absorbed by the X-ray shield members 31 and 33, exists to a certain extent. To improve the X-ray shield (absorption) property, it is preferable to increase, as much as possible, the thickness in the z direction of each of the X-ray shield members 31 and 33, that is, an aspect ratio. For example, it is preferable to shield (absorb) at least 90% of the irradiation X-ray when the tube voltage of the X-ray tube is 50 kV. In this case, it is preferable that the thickness of each of the X-ray shield members 31 and 33 is at least 30 μm (Au equivalent thickness).

With the use of the first and second absorption gratings 21 and 22, the intensity of the fringe image is modulated by the superposition of the G1 image of the first absorption grating 21 and the second absorption grating 22. The FPD 20 captures an image of the modulated fringe image. There is a slight difference between a pattern period of the G1 image at the second absorption grating 22 and the grating pitch p₂ of the second absorption grating 22 due to production error and layout error. This slight difference causes moiré fringes in the intensity-modulated fringe image. So-called rotational moiré fringes occur when there is an error in the grating arrangement direction of the first and second absorption gratings 21 and 22, that is, the grating arrangement directions of the first and second absorption gratings 21 and 22 are different. Such moiré fringes do not raise a problem as long as the period of the moiré fringes in the x or y direction is larger than the arrangement pitch of the pixels 40. If possible, it is preferable to prevent the occurrence of moiré fringes. The moiré fringes, however, can be used for checking a scanning amount during the fringe-scanning, which will be described later.

When the object H is arranged between the X-ray source 11 and the first absorption grating 21, the fringe image changed or modulated by the object H is detected by the FPD 20. An amount of the change or modulation is in proportion to an angle of the X-ray deflected by the refraction of the object H. Analyzing the fringe image detected by the FPD 20 produces the phase contrast image of the object H.

Next, an analytical method of the fringe image is described. FIG. 4 shows an X-ray path 50 where the object H is absent and an X-ray path 51 where the object H is present. When the object H is absent, the X-ray traveling along the X-ray path 50 passes through the first and second absorption gratings 21 and 22 and then enters the FPD 20. On the other hand, when the object H is present, the X-ray path 51 is refracted in accordance with the phase shift distribution Φ(x) in the x direction of the object H. In this case, the X-ray traveling along the X-ray path 51 passes through the first absorption grating 21, and then is shielded by the X-ray shield member 33 of the second absorption grating 22.

The phase shift distribution Φ(x) of the object H is represented by a mathematical expression (4) where “n(x, z)” denotes refractive index distribution of the object H, “z” denotes an X-ray traveling direction. Here, for the sake of simplicity, the y coordinate is omitted.

$$Φ ( x ) = \frac{2 π}{λ} \int [ 1 - n ( x , z ) ] d x \qquad ( 4 )$$

The G1 image projected from the first absorption grating 21 to the second absorption grating 22 is displaced in the x direction with an amount corresponding to a refraction angle φ of the X-ray refracted by the object H. Because the refraction angle φ of the X-ray is extremely small, a displacement amount Δx is approximately expressed by a mathematical expression (5).

Δx≈L₂ φ (5)

Here, the refraction angle φ is represented by a mathematical expression (6) using an X-ray wavelength λ and the phase shift distribution Φ(x) of the object H.

$$ϕ = \frac{λ}{2 π} \frac{\partial Φ ( x )}{\partial x} \qquad ( 6 )$$

Thus, the displacement amount Δx of the G1 image, caused by the X-ray refracted by the object H, relates to the phase shift distribution Φ(x) of the object H. A mathematical expression (7) represents a relation between the displacement amount Δx and a phase shift value ψ of the intensity modulated signal obtained from each pixel 40 of the FPD 20. The phase shift value ψ is a value of the phase shift between the case where the object H is present and the case where the object H is absent.

$$ψ = \frac{2 π}{{p}_{2}} Δ x = \frac{2 π}{{p}_{2}} {L}_{2} ϕ \qquad ( 7 )$$

To be more precise, the mathematical expression (7) is a relational expression representing a relation between the displacement amount Δx and a phase shift value ψ of the intensity modulated signal of the pixel 40 of the first grating module 22a with no inclination relative to the scanning direction of the second absorption grating 22. The remaining second to fifth grating modules 22b to 22e are inclined relative to the scanning direction. Offset values Δψ(θ) corresponding to the inclination angles θ of the second to fifth grating modules 22b to 22e are added to the phase shift values ψ of the intensity modulated signals obtained from the pixels 40 corresponding to the second to fifth grating modules 22b to 22e, respectively. Accordingly, it is necessary to subtract the offset values Δψ(θ) from the phase shift values ψ of the intensity modulated signals obtained from the pixels 40 corresponding to the second to fifth grating modules 22b to 22e, respectively.

Accordingly, the phase shift value of the intensity modulated signal of each pixel 40 is obtained and then the corresponding offset value is subtracted from the phase shift value. Thereby, the phase shift value ψ is provided. The phase shift value ψ is applied to the mathematical expression (7). Thereby, the refraction angle φ is obtained. Then, with the application of the mathematical expression (6), a derivative of the phase shift distribution Φ(x) is obtained. The derivative is integrated with respect to x. Thereby, the phase shift distribution Φ(x) of the object H, that is, the phase contrast image of the object H is produced. In this embodiment, the above-described phase shift value ψ is calculated using a fringe-scanning method described below.

In the fringe-scanning method, imaging is performed while one of the first and second absorption gratings 21 and 22 is translationally moved relative to the other in the x direction. In other words, the imaging is performed while the phases of the grating periods of the first and second absorption gratings 21 and 22 are changed. In this embodiment, the scan mechanism 23 moves the second absorption grating 22. The moiré fringes move in accordance with the movement of the second absorption grating 22. When the translational length or the scanning amount reaches one period of the grating period (namely, when the phase change reaches 2π), the moiré fringes return to the original position.

In this embodiment, with reference to the first grating module 22a of the second absorption grating 22, with no inclination relative to the scanning direction, the second absorption grating 22 is moved by an integral fraction of the grating pitch p₂. The FPD 20 captures fringe images while the second absorption grating 22 is moved. From each pixel, the intensity modulated signal is obtained from the captured fringe images. The phase differential image generator 24 in the image processor 14 calculates the phase shift value ψ of the intensity modulated signal for each pixel. The remaining second to fifth grating modules 22b to 22e are inclined relative to the scanning direction. Accordingly, actual scanning pitches for the second to fifth grating modules 22b to 22e differ depending on the inclination angles θ. The difference in the scanning pitch is caused by the above-described offset value Δψ(θ).

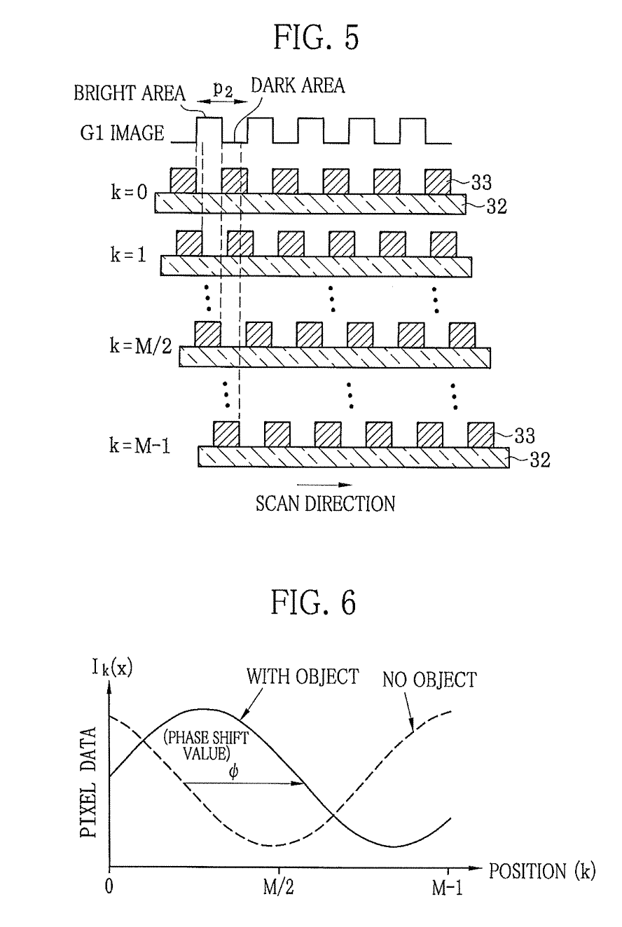

In FIG. 5, the second absorption grating 22 is moved with a scanning pitch (p₂/M), that is, the grating pitch p₂ divided by M (an integer equal to or larger than two). The scan mechanism 23 translationally moves the second absorption grating 22 at each of the M scanning positions where k=0, 1, 2, . . . , M-1 in this order. In FIG. 5, an initial position of the second absorption grating 22 is a position (k=0) where the dark areas of the G1 image substantially coincide with the X-ray shield members 33 at the second absorption grating 22 in a state that the object H is absent. The initial position may be any position where k=0, 1, 2, . . . , or M-1.

When the second absorption grating 22 is at the position where k=0, the X-ray passing though the second absorption grating 22 is mainly the X-ray not refracted by the object H. As the second absorption grating 22 is sequentially moved to positions where k=1, 2, . . . , an X-ray component not refracted by the object H decreases while an X-ray component refracted by the object H increases in the X-ray passing through the second absorption grating 22. Particularly, when the second absorption grating 22 is at the position where k=M/2, the X-ray passing through the second absorption grating 22 is mainly the X-ray refracted by the object H. When the second absorption grating 22 is past the position where k=M/2, on the contrary, the X-ray component refracted by the object H decreases while the X-ray component not refracted by the object H increases in the X-ray passing through the second absorption grating 22.

When an image is captured using the FPD 20 at each of the positions where k=0, 1, 2, . . . , and M-1, M frames of pixel data are obtained from each pixel 40. Hereafter, a method to calculate the phase shift value ψ of the intensity modulated signal of each pixel 40 using the M frames of pixel data is described. A mathematical expression (8) represents pixel data Iₖ(x) of each pixel when the second absorption grating 22 is located at a position k.

$${I}_{k} ( x ) = {A}_{0} + {\sum }_{n > 0} {A}_{n} exp [ 2 π i \frac{n}{{p}_{2}} \{ {L}_{2} ϕ ( x ) + \frac{k {p}_{2}}{M} \} ] \qquad ( 8 )$$

Here, “x” denotes a coordinate, of the pixel, in the x-direction. “A₀” denotes the intensity of the incident X-ray. “Aₙ” denotes a value corresponding to the contrast of the intensity modulated signal. (Here, “n” is a positive integer). “φ(x)” denotes the refraction angle φ in the form of a function of the coordinate x of the pixel 40.

Using a relational expression (9), the refraction angle φ(x) is represented by a mathematical expression (10).

$$\begin{matrix}{\sum }_{k = 0}^{M - 1} exp ( - 2 π i \frac{k}{M} ) = 0 & ( 9 ) \\ ϕ ( x ) = \frac{{p}_{2}}{2 π {L}_{2}} arg [ {\sum }_{k = 0}^{M - 1} {I}_{k} ( x ) exp ( - 2 π i \frac{k}{M} ) ] & ( 10 )\end{matrix}$$

Here, “arg [ ]” denotes calculation of argument and corresponds to the phase shift value ψ of the intensity modulated signal obtained from each pixel. Based on the mathematical expression (10), the phase shift value ψ is calculated using the M frames of pixel data (the intensity modulated signal) obtained from each pixel 40. Thereby, the refraction angle φ(x) is obtained. Thus, the derivative of the phase shift distribution Φ(x) is obtained.

To be more specific, as shown in FIG. 6, the values of the M frames of pixel data obtained from the pixel 40 periodically change relative to the position k of the second absorption grating 22 in a period of the grating pitch p₂. In FIG. 6, broken lines denote changes in the pixel data (intensity modulated signal) when the object H does not exist. A solid line denotes changes in the pixel data (intensity modulated signal) when the object H exists. A phase difference between a waveform shown in the broken lines and a waveform shown in the solid line represents the phase shift value ψ of the intensity modulated signals obtained from each pixel.

In the above description, a y-coordinate in the y direction of the pixel 40 is not considered. To obtain the two dimensional distribution of the phase shift ψ(x, y) in x and y directions, the same or similar operation as above is performed to each y-coordinate. The distribution of the phase shift ψ(x, y) corresponds to the phase differential image.

The inclination angle of θ the grating module is not considered in the phase shift value ψ(x, y) obtained using the mathematical expression (10). To obtain actual phase shift value caused only by the object H, it is necessary to subtract the above-described offset value Δψ(θ) corresponding to the inclination angle θ. The offset value Δψ(θ) is stored in the offset value storage 25. The correction processing section 26 corrects the phase shift value ψ(x, y), that is, the phase differential image, using the offset value Δψ(θ).

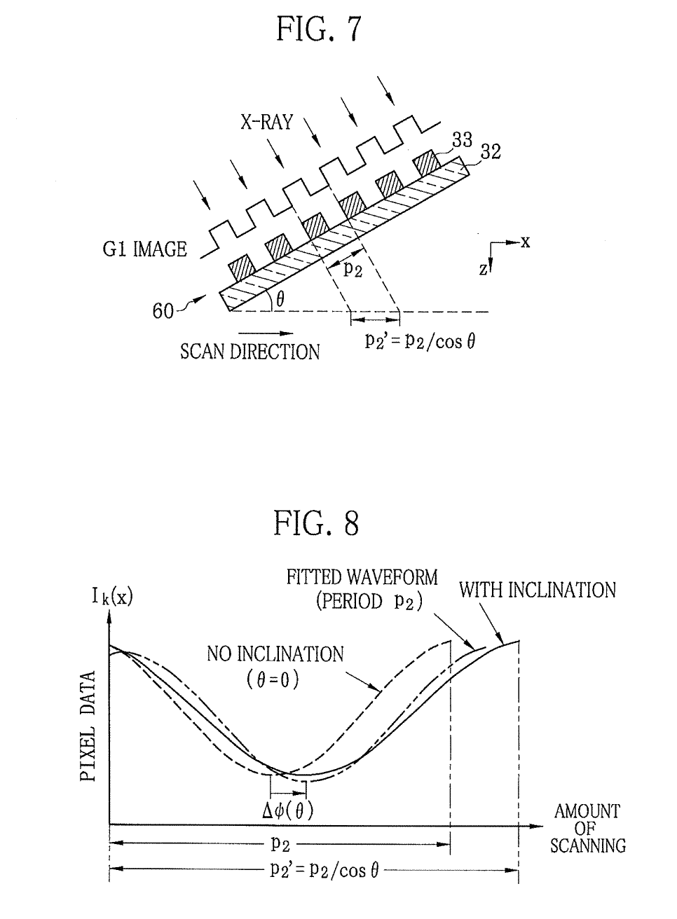

Next, a calculation method of the offset value Δψ(θ) to be stored in the offset value storage 25 is described. FIG. 7 shows one of the second to fifth grating modules 22b to 22e of a grating module 60. The grating module 60 has a grating period p₂. The grating module 60 has an inclination angle θ relative to the scanning direction. Accordingly, an effective grating period p₂′ is represented by a mathematical expression p₂′=p₂/cos θ.

Accordingly, when the object H is absent, as shown in FIG. 8, the period of the intensity modulated signal corresponding to the grating module with no inclination (θ=0) coincides with the grating period p₂. On the other hand, the period of the intensity modulated signal corresponding to the grating module with the inclination angle θ is the effective grating period p₂′. The intensity modulated signal corresponding to the inclination angle θ differs from the intensity modulated signal obtained when θ=0 not in phase but in period. A change in the period is converted into a phase shift value. Thereby, the offset value Δψ(θ) is calculated.

To be more specific, using a least square method, a sine wave (fitted waveform), having the period p₂, best-fitted to the waveform of the intensity modulate signal having the period p₂′ is calculated. The period p₂′ depends on the inclination angle. The offset value Δψ(θ) is the phase shift value of the fitted waveform relative to the waveform obtained when θ=0. The above-described method for calculating the phase shift value is disclosed in “Applied Optics, Introduction to Optical Measurement” (ToyohikoYATAGAI, Second Edition, Maruzen, Co., Ltd, Feb. 15, 2005, pp 196 to 198), for example.

Based on the above calculation method, the offset value Δψ(θ) is represented by a mathematical expression (11).

$$Δ ϕ ( θ ) = arc tan [ \frac{{\sum }_{k = 1}^{M} cos ( 2 π \frac{k}{M} cos θ ) sin ( 2 π \frac{k}{M} )}{{\sum }_{k = 1}^{M} cos ( 2 π \frac{k}{M} cos θ ) cos ( 2 π \frac{k}{M} )} ] \qquad ( 11 )$$

The above mathematical expression (11) contains M (positive integer) as a parameter. When M is sufficiently large to allow the offset value Δψ(θ) to be a function only of θ, the above mathematical expression (11) is changed into a mathematical expression (12).

$$Δ ϕ ( θ ) = arc tan [ \frac{{\int }_{0}^{2 π} cos ( ( cos θ ) x ) sin x d x}{{\int }_{0}^{2 π} cos ( ( cos θ ) x ) cos x d x} ] \qquad ( 12 )$$

The integration included in the above mathematical expression (12) is analytically calculable. The mathematical expression (12) is changed into a mathematical expression (13).

$$Δ ϕ ( θ ) = arc tan [ \frac{1 - cos ( 2 π ( 1 - cos θ ) )}{cos θ sin ( 2 π ( 1 - cos θ ) )} ] \qquad ( 13 )$$

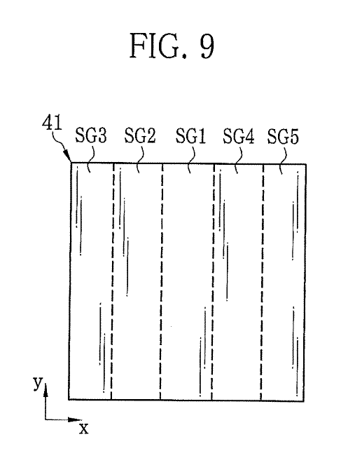

As shown in FIG. 9, the offset value storage 25 stores an offset value Δψ(θ), calculated using the mathematical expression (13), for each of the segments SG1 to SG5 into which the imaging section 41 (detection surface) of the FPD 20 is divided. The segments SG1 to SG5 correspond to the first to fifth grating modules 22a to 22e of the second absorption grating 22, respectively.

For example, when the distance (L₁+L₂) between the X-ray focal point 11a and the second absorption grating 22 is 130 cm, and a width of each of the first to fifth grating modules 22a to 22e in the circumferential direction is 3 cm, the inclination angles θ of the first to fifth grating modules 22a to 22e are 0°, 1.32°, 2.64°, −1.32°, −2.64°, respectively. In this case, the offset value storage 25 stores the values shown in Table 1 as the offset values Δψ(θ) on a segment-by-segment basis. The segments SG1 to SG5 correspond to the first to fifth grating modules 22a to 22e, respectively.

TABLE 1

| SEGMENT | θ | Δψ (θ) |
|---|---|---|
| SG1 | 0° | 0 |
| SG2 | 1.32° | 8.36 × 10⁻⁴ (rad) |
| SG3 | 2.64° | 3.35 × 10⁻³ (rad) |
| SG4 | −1.32° | 8.36 × 10⁻⁴ (rad) |
| SG5 | −2.64° | 3.35 × 10⁻³ (rad) |

The correction processing section 26 groups or classifies the phase shift values ψ(x, y) of the intensity modulated signals, obtained by the phase differential image generator 24, according to the segments SG1 to SG5. Then, the correction processing section 26 obtains the offset value Δψ(θ) of each segment from the offset value storage 25 to perform the offset correction of the phase shift value ψ(x, y) on a segment-by-segment basis.

In the above configured X-ray imaging system 10, when the operator inputs an instruction for imaging using the console 17 in a state that the object H is arranged between the X-ray source 11 and the imaging unit 12, the X-ray source 11 emits X-ray to the object H. The X-ray passes through the object H, the first absorption grating 21, and the second absorption grating 22. Thereby, the intensity of the fringe image is modulated. The modulated fringe image is detected by the FPD 20. The fringe image is detected at each scanning position while the second absorption grating 22 is moved by a predetermined scanning pitch. The obtained fringe images are stored as image data in the memory 13.

Then, based on the multiple frames of the image data stored in the memory 13, the phase differential image generator 24 generates the phase shift value ψ(x, y) (corresponding to the phase differential image) of the intensity modulated signal. The correction processing section 26 groups or classifies the phase shift values (x, y) according to the above-described segments SG1 to SG5. The correction processing section 26 performs the offset correction on a segment-by-segment basis using the offset value Δψ(θ) stored in the offset value storage 25.

Thereafter, the phase contrast image generator 27 integrates the phase differential image to be converted into the phase contrast image. The phase contrast image is stored in the image storage 15, and then displayed on the monitor of the console 17.

In this embodiment, the offset value Δψ(θ) calculated using the mathematical expression (13) is stored in the offset value storage 25. When the inclination angle θ is small enough, a mathematical expression (14), that is, an approximate solution of the mathematical expression (13) may be used to calculate the offset value Δψ(θ).

$$Δ ϕ ( θ ) \approx \frac{( 1 - cos θ ) π}{cos θ} \qquad ( 14 )$$

It is preferable that the offset value storage 25 is a rewritable memory such as flash memory so as to change the offset values Δψ(θ) when the inclination angles θ are changed.

In this embodiment, each of the first and second absorption gratings 21 and 22 is composed of multiple grating modules divided in the x direction. In addition, each grating module may be further divided in the y direction. Namely, each of the first and second absorption gratings 21 and 22 may be composed of multiple grating modules arranged in matrix.

In this embodiment, the first absorption grating 21 linearly projects the X-ray passed through the slits of the X-ray shield member 31. Alternatively, the X-ray may be diffracted at the slits to cause the so-called Talbot effect (see, for example, U.S. Pat. No. 7,180,979). In this case, the distance L₂ between the first and second absorption gratings 21 and 22 needs to be set at the Talbot length. A phase grating (phase diffraction grating) can be used instead of the first absorption grating 21. The phase grating, used instead of the first absorption grating 21, projects the fringe image (self image) generated by the Talbot effect onto the FPD 20.

The only difference between the phase grating and the absorption grating is the thickness of the high X-ray absorption material (the X-ray shield member). The thickness of the X-ray shield member of the absorption grating is at least approximately 30 μm (Au equivalent thickness). On the other hand, the thickness of the X-ray shield member of the phase grating is approximately in a range from 1 μm to 5 μm. In the phase grating, the high X-ray absorption material modulates the phase of the incident X-ray emitted from the X-ray source 11 by a predetermined value (preferably, π or π/2). Thereby, a fringe image (the self image) is generated due to the Talbot effect.

In this embodiment, the object H is arranged between the X-ray source 11 and the first absorption grating 21. The phase contrast image can be produced even if the object H is arranged between the first absorption grating 21 and the second absorption grating 22.

### Second Embodiment

In the above embodiments, the second absorption grating 22 is provided independently of the FPD 20. With the use of an X-ray detector disclosed in U.S. Pat. No. 7,746,981 corresponding to Japanese Patent Laid-Open Publication No. 2009-133823, the second absorption grating 22 can be eliminated. The X-ray image detector is a direct conversion type X-ray image detector provided with a conversion layer and charge collection electrodes. The conversion layer converts the X-ray into electric charge. The charge collection electrodes collect the converted electric charge. The charge collection electrode in each pixel is composed of linear electrode groups arranged to have mutually different phases. Each linear electrode group is composed of linear electrodes arranged at a predetermined period and electrically connected to each other. The charge collection electrode constitutes the intensity modulator.

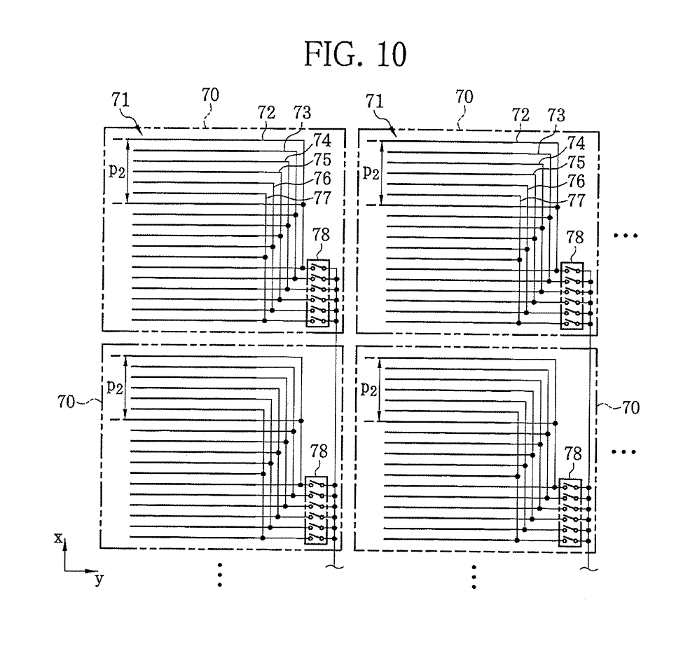

In FIG. 10, an X-ray image detector (FPD) of this embodiment is composed of pixels 70 arranged in two dimensions (x and y directions) at a constant pitch. In each pixel 70, a charge collection electrode 71 is formed. The charge collection electrode 71 collects electric charge converted by the conversion layer. The charge collection electrode 71 is composed of first to sixth linear electrode groups 72 to 77. The phase of the arrangement period of each linear electrode group is shifted by π/3. For example, when the phase of the first the linear electrode group 72 is zero, the phase of the second linear electrode group 73 is π/3, the phase of the third linear electrode group 74 is 2π/3, the phase of the fourth linear electrode group 75 is π, the phase of the fifth linear electrode group 76 is 4π/3, and the phase of the sixth linear electrode group 77 is 5π/3.

Each pixel 70 is further provided with a switch group 78 for reading the electric charge collected by the charge collection electrode 71. The switch group 78 is composed of TFT switches respectively provided to the first to the sixth linear electrode groups 72 to 77. The switch group 78 is controlled to separately read the electric charge collected by each of the first to the sixth linear electrode groups 72 to 77. Thereby, six different fringe images with mutually different phases are obtained per image capture. Using the six different fringe images, the phase contrast image is produced based on the phase shift value of the intensity modulated signal obtained from each pixel.

Using the above-configured X-ray image detector instead of the FPD 20 eliminates the need for the second absorption grating 22 in the imaging unit 12. As a result, cost is reduced and the lower-profile is achieved. In this embodiment, the intensity modulated signal of each pixel is obtained per image capture. Accordingly, physical scanning for the fringe-scanning is unnecessary and thus the scan mechanism 23 is eliminated. Instead of the charge collection electrode 71, other charge collection electrodes disclosed in U.S. Pat. No. 7,746,981 may be used.

As described above, when the second absorption grating 22 is eliminated, the G1 image projected onto the detection surface of the X-ray image detector is deformed depending on the inclination angles θ of the first to fifth grating modules 21a to 21e of the first absorption grating 21. Accordingly, the effective pattern period of the G1 image at the detection surface is p₂′=p₂/cos θ. Here, p₂ is an arrangement pitch of the linear electrodes of each of the linear electrode groups 72 to 77.

In this embodiment, as with the above-described first embodiment, the correction processing section 26 corrects the phase differential image using the offset value Δψ(θ) stored in the offset value storage 25. To be more specific, in the offset value storage 25, the offset values Δψ(θ) corresponding to the inclination angles θ of the first to fifth grating modules 21a to 21e of the first absorption grating 21 are stored. The detection surface of the X-ray image detector is divided into segments in the same manner as in FIG. 9. The offset correction of the phase shift value ψ(x, y) is performed using the offset values Δψ(θ) corresponding to the segments, respectively.

In another embodiment not using the second absorption grating 22, a fringe pattern (G1 image) obtained with the X-ray image detector is periodically sampled while the phase is changed through signal processing. Thus, the intensity of the fringe pattern is modulated.

The inclination angles of the grating modules of the first absorption grating 21 and the second absorption grating 22 may change due to temperature and the like. A mechanism for adjusting the inclination angle may be provided.

In addition to the radiation imaging system used for performing medical diagnoses, the above-described embodiments can be applied to other radiation imaging systems, for example, an industrial radiation imaging system such as non-destructive inspection. Instead of or in addition to the X-ray, gamma rays and the like may be used as the radiation.

Various changes and modifications are possible in the present invention and may be understood to be within the present invention.

What is claimed is:

1. A radiation imaging system comprising:
a first grating composed of two or more first grating modules arranged along at least a part of a virtual first cylindrical surface having a virtual line as a center axis, the virtual line passing through a focal point of a radiation source, a grating line of the first grating being in the same direction as the virtual line;
a second grating composed of two or more second grating modules arranged along at least a part of a virtual second cylindrical surface, the second cylindrical surface being coaxial with the first cylindrical surface and having a larger radius than the first cylindrical surface, a grating line of the second grating being in the same direction as the virtual line;
a scanning section for moving one of the first grating and the second grating relative to the other in a scanning direction orthogonal to the virtual line;
a radiation image detector having a detection surface for detecting radiation passed through the first grating and the second grating to obtain pixel data while one of the first grating and the second grating is moved relative to the other by the scanning section, the detection surface being divided into two or more segments, the segments corresponding to the respective second grating modules;
a phase differential image generator for calculating a phase shift value of an intensity modulated signal to produce a phase differential image based on the phase shift value, the intensity modulated signal representing a relation between the pixel data and a relative position between the first grating and the second grating;
an offset value storage for storing an offset value of the phase shift value, the offset value corresponding to an inclination angle of the second grating module relative to the scanning direction, the offset value storage storing the offset values corresponding to the respective segments; and
a correcting section for correcting the phase differential image on a segment-by-segment basis based on the offset value.

2. The radiation imaging system of claim 1, wherein the offset value is a value calculated by (1−cos θ)π/cos θ where θ denotes the inclination angle.

3. The radiation imaging system of claim 1, further including a phase contrast image generator for integrating the phase differential image corrected by the correcting section to produce a phase contrast image.

4. The radiation imaging system of claim 1, wherein each of the first grating modules is an absorption grating and projects the radiation from the radiation source as a fringe image to the second grating module corresponding to the first grating module.

5. The radiation imaging system of claim 1, wherein each of the first grating modules is a phase grating and forms a fringe image of the radiation from the radiation source at the second grating module corresponding to the first grating module due to Talbot effect.

6. A radiation imaging system comprising:
a grating composed of two or more grating modules arranged along at least a part of a virtual cylindrical surface having a virtual line as a center axis, the virtual line passing through a focal point of a radiation source, a grating line of the grating being in the same direction as the virtual line;
a radiation image detector having a detection surface divided into two or more segments, the segments corresponding to the respective grating modules, the detection surface having a charge collection electrode per pixel, the charge collection electrode collecting charge converted by a radiation conversion layer, the charge collection electrode being composed of two or more linear electrode groups arranged to have mutually different phases in a direction orthogonal to the virtual line,
a phase differential image generator for calculating a phase shift value of an intensity modulated signal to produce a phase differential image based on the phase shift value, the intensity modulated signal representing changes in pixel data obtained by each of the linear electrode groups;
an offset value storage for storing an offset value of the phase shift value, the offset value corresponding to an inclination angle of the grating module relative to the direction orthogonal to the virtual line, the offset value storage storing the offset values corresponding to the respective segments; and
a correcting section for correcting the phase differential image on a segment-by-segment basis based on the offset value.

7. An offset correction method for a radiation imaging system comprising the steps of:
moving one of a first grating and a second grating relative to the other in a direction orthogonal to a virtual line, the first grating being composed of two or more first grating modules arranged along at least a part of a virtual first cylindrical surface having the virtual line as a center axis, the virtual line passing through a focal point of a radiation source, a grating line of the first grating being in the same direction as the virtual line, the second grating being composed of two or more second grating modules arranged along at least a part of a virtual second cylindrical surface, the second cylindrical surface being coaxial with the first cylindrical surface and having a larger radius than the first cylindrical surface, a grating line of the second grating being in the same direction as the virtual line;
detecting radiation passed through the first grating and the second grating by a detection surface of a radiation image detector to obtain pixel data while one of the first grating and the second grating is moved relative to the other, the detection surface being divided into two or more segments, the segments corresponding to the respective second grating modules;
calculating a phase shift value of an intensity modulated signal to produce a differential image based on the phase shift value, the intensity modulated signal representing a relation between the pixel data and a relative position between the first grating and the second grating; and
correcting the phase differential image on a segment-by-segment basis based on an offset value of the phase shift value, the offset value corresponding to an inclination angle of the second grating module relative to the direction orthogonal to the virtual line, the offset values being stored corresponding to the respective segments.
